(19) United States
(12) Patent Application Publication
(10) Pub. No.: US 2011/0312379 A1
(43) Pub. Date: Dec. 22, 2011

(54) SYNCHRONIZING DIGITAL CONTENT

(75) Inventors: Gary N. Wallace, JR., Butler, PA (US); Adam L. Berger, Pittsburgh, PA (US)

(73) Assignee: Penthera Partners, Inc.

(21) Appl. No.: 12/819,828

(22) Filed: Jun. 21, 2010

(51) Int. Cl. H04M 1/00

(52) U.S. Cl. 455/557

(57) ABSTRACT

Among other things, at a local device connected to a network, updating, of a mobile device that is nearby the local device, from one state to another state, is assisted. The states of the mobile device are associated with digital content. The updating is based on information at a server that is accessible through the network from the local device. The updating is assisted without requiring execution on the local device of code that is persistent on the local device.

### BACKGROUND

This description relates to synchronizing digital content.

Mobile phone networks in developed countries support both voice calling and data applications such as email, TV, music, and video uploading. By contrast, in some emerging markets, like Brazil, India, China, and Africa, the mobile phone network (such as a 2G network like GSM) does not reliably support mobile data applications.

Although Internet access may be available in these areas using a personal computer (PC) and a broadband or dial-up connection, such computers are often too expensive for private ownership. Therefore, PCs in these areas are typically shared at Internet cafes, libraries, or kiosks. These public PCs are often “locked down” by the owners, i.e., set up to prevent users from altering the default configurations of the PCs. For example, such PCs may be configured to prevent customers from installing software applications.

Synchronizing data between a mobile device (MD) and a second computer is a required function for many applications. The second computer may be either physically nearby to the MD, or remote. The connection between the MD and second computer may be physical (using a USB cable, for example), or it may be over the Internet. In the latter case, a PC may act as a proxy to convey instructions and data between the MD and the remote second computer; the PC provides the Internet access, through a network adapter, and shuttles data and instructions between the Internet and the MD. For example, pictures taken using an MD may be uploaded to a server on the Internet, through the PC. Or a list of contacts and their phone numbers can be transferred from the Internet to the MD, again using the PC as a proxy. Music tracks purchased from an online music store and stored on the PC can, using this mechanism, be transferred to the MD. These examples require software applications to be installed on the PC, to interact with the second computer and manage the synchronization of data between the second computer and the MD.

For example, Apple's iTunes is a software product intended for installation on a PC; among its functions is to transfer purchased content (music, TV shows, movies) from the Internet to a MD, through the PC.

| Mobile Device | PC Synchronization Software |
|---|---|
| iPod/iPhone/iPad | iTunes |
| Palm PDA/Smartphones | Palm Desktop |
| Nokia phone | Nokia PC Suite |
| Blackberry | Blackberry Desktop Manager |

Examples of applications that can be installed on PCs to manage synchronization for mobile devices are set forth in the following table:

Mobile devices (MDs) synchronize digital content with remote computers in a variety of scenarios, for example:
A subscription-based TV service that, at regular intervals, delivers episodes of a TV show to a user's MD, where they are stored for later presentation, for example, the system described in U.S. patent application Ser. No. 12/609,515, filed Oct. 20, 2009, and incorporated by reference here in its entirety.
A service that delivers updates to software applications installed on a user's MD as the updates are released, for example, updates of an arcade game or a productivity tool or a widget.
A sampler music service that delivers new tracks or albums from an Internet server to the user's MD where they are stored for later presentation.
A service that delivers chapters of an audiobook or ebook to the user's MD, where they are stored for later presentation. The chapters are delivered sequentially, one at a time or in small groups at a time.
A messaging or other “personalized broadcasting” content service that delivers email, blogs, or Twitter feeds, for example, to the user's MD, where the content is stored for later presentation.
A service that uploads pictures or video, for example, that have been taken using the camera of the user's MD and stored on the MD, to a remote application server (such as Flickr) for subsequent processing or redistribution or both.

Such services require an Internet connection to transmit digital content between the MD and a second computer. However, the Internet connection can be intermittent, and is not required to be active when the user is consuming or producing the digital content. For example, a user may connect his MD to the Internet between 1 PM and 2 PM on Tuesday, and during that period downloads new audiobook chapters, but this same user may not consume (e.g., read) those chapters until Wednesday evening.

We sometimes call these applications non-real-time mobile content transport applications, for example, because they may transfer digital content between the MD and a second computer at times other than when the user of the MD is acquiring or consuming the content.

By contrast, in what might be called a real-time mobile content transport application, the transport and the consumption or presentation of content occur essentially simultaneously. One example is a video-streaming application (such as MobiTV or Qualcomm's MediaFLO), which delivers video in real time to a MD; the video is presented and consumed when and as it is received. Another example is Pandora, which can stream music through the Internet to an MD, and the music is performed at the same time. These applications require the MD to have an active Internet connection when the content is consumed or acquired.

### SUMMARY

In general, in an aspect, at a local device connected to a network, updating, of a mobile device (MD) that is nearby the local device, from one state to another state, is assisted. The states of the mobile device are associated with digital content. The updating is based on information at a server that is accessible through the network from the local device. The updating is assisted without requiring execution on the local device of code that is persistent on the local device.

Implementations may include one or more of the following features. The local device includes a computer. The local device is connected to the Internet. The MD is nearby the local device only temporarily. The updating includes updating a state file on the MD. The digital content includes items to be presented to a user of the MD. Updating the MD includes updating digital content that is to be presented to the user of the MD. The information at the server relates to digital content that is available for presentation to a user of the MD. The MD is connected to the local device to assist the updating. Connecting the MD to the local device includes making a cable connection. Connecting the MD to the local device includes making a wireless connection. Assisting the updating includes actions of a user. Assisting the updating includes actions by the local device. Assisting the updating includes actions by the MD. Code is executed on the MD to assist in the updating. The user is alerted to actions to be performed by the user to assist the updating. The assisting of the updating includes operation of a browser on the local device. The assisting of the updating includes executing non-persistent code. The non-persistent code includes scripts delivered through a browser. The non-persistent code includes hypertext markup code.

In general, in an aspect, an alert is provided to a user of a MD to cause the user to connect the MD to a network-connected local device. Implementations may include one or more of the following features. The network-connected local device helps to synchronize content on a server with content on the mobile device. The alert is provided by displaying a message on the MD. The alert is provided by rendering a sound on the MD. The network includes the Internet. The local device includes a computer. The content includes items to be presented to the user on the MD. The alert indicates to the user to cause the local device to connect to the server through a browser. The alert identifies a URL of the server. The alert instructs a user of the MD to launch a browser on the local device. The alert is delivered as a text message to the MD.

In general, in an aspect, at a local device that is connected by a network to a server, executing non-persistent code to acquire a state of a MD that is nearby the local device, the state being related to content stored on the MD.

Implementations may include one or more of the following features. Non-persistent code acquires a current state from the MD. The non-persistent code delivers to the server current state of the MD. The non-persistent code scans the MD for a specific file that includes a current state of the MD.

In general, in an aspect, at a local device that is connected by a network to a server, alerting a user to copy a file, received from the server at the local device, from the local device to a MD that is nearby the local device, the file containing information associated with synchronization of content between the server and the MD.

Implementations may include one or more of the following features. The file is copied to the MD at a location that is known by the MD to contain synchronization information.

These and other aspects, features, and implementations, and combinations of them, can be expressed as apparatus, methods, systems, means for performing functions, business methods, program products, components, and in other ways.

Other aspects and features will become apparent from the following description and from the claims.

### DESCRIPTION

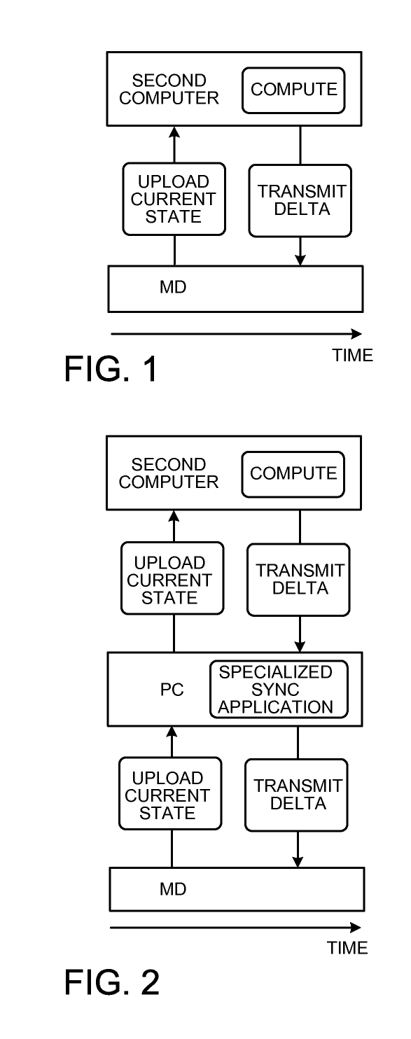

FIGS. 1, 2, and 3 are block/flow diagrams.

FIG. 4 is a block diagram.

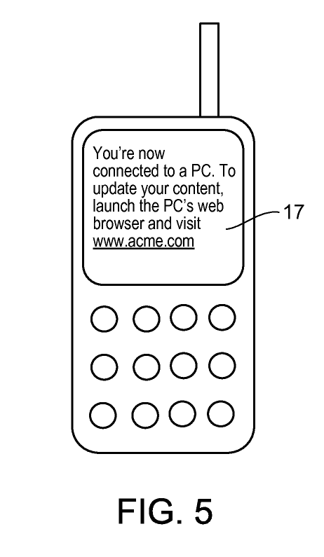

FIG. 5 is a view of a mobile phone message.

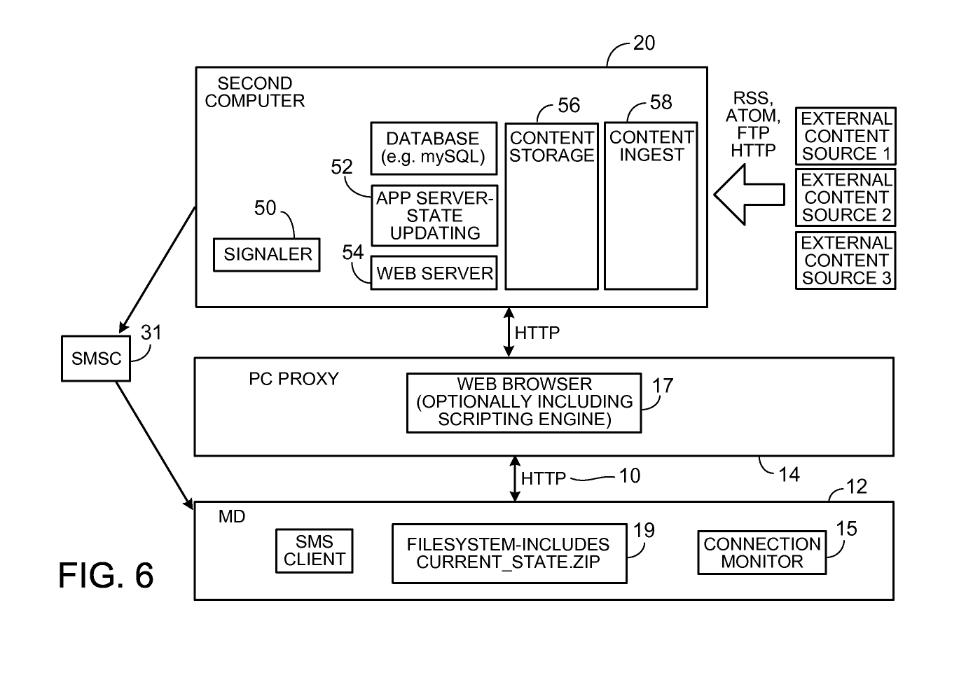

FIG. 6 is a block diagram.

We describe here a way, among other things, to use a “locked-down” public PC to allow a mobile device (MD) to synchronize data with a remote computer.

Consider a user who has a MD that includes a reasonable amount of persistent storage for files, and who has access to a public shared PC on which software applications, for example, digital content synchronization applications, may not be installed. The user's access to the PC is infrequent; that is, the MD may be connected to the PC for digital content synchronization with a remote server only intermittently. The user wants to use a non-real-time mobile content transport application on his MD.

### General Synchronization Method

Content on a MD can be transferred by the MD to and from (e.g., synchronized with) a second device (for example, a locally available or remote computer or server),

CONNECT: The MD connects to the second computer and communicates (uploads) its current state to the second computer (Here we do not address how the connection is made.).

COMPUTE: As shown in FIG. 1, the second device (we sometimes call the second device a second computer) compares the current state of the MD to a new state for the MD. The second computer calculates (computes), for example, what steps (the delta) are needed to bring the MD to the new state. This delta may include, for example, the steps of deleting files on the MD and delivering new files to the MD.

TRANSMIT: The second computer transmits the delta as a file to the MD.

PERFORM: The MD reads the delta file. It deletes files and stores new files as instructed.

The state of the MD may include, for each of the files stored on the MD, the name of the file, a timestamp for when it was delivered to the MD, and the number of times the file has been accessed, consumed, or presented to the user of the MD.

Examples of the sequence include the following:

1. The MD reports in the CONNECT step that its storage contains last week's episode of a podcast or TV show. The second computer is aware of a more recent episode. In the TRANSMIT step, the second computer instructs the MD to delete last week's episode and download the new episode. The MD implements these instructions in PERFORM.
2. The MD reports in the CONNECT step that its storage contains a video that the user has acquired recently using a camera that is part of the MD. The second computer determines in the COMPUTE step that it has not yet received this video. In the TRANSMIT step, the second computer instructs the MD to upload this video. The MD does so in PERFORM.
3. The MD reports in the CONNECT step that its storage contains version 4.3 of an application. The second computer is aware of version 5.3 of this application. In TRANSMIT, the second computer instructs the MD to download the new version and install it. In PERFORM, the MD does so.
4. The MD reports in the CONNECT step that a specific recording of J. S. Bach Minuet in G Minor has been presented sixteen times on the MD since the prior CONNECT step. In the COMPUTE step, the second computer uses this data to consult its own database of music tracks and finds similar tracks that the user may enjoy. In TRANSMIT, the server instructs the MD to download these tracks, which the MD does, in PERFORM.
5. The MD reports in the CONNECT step that episode 1 of a TV show has been presented. In the COMPUTE step, the server (e.g., the second computer) consults its directory and finds episode 2 of this TV show. In the TRANSMIT step, the server instructs the MD to download this episode, which the MD does, in the PERFORM step.

Among known ways to implement such a synchronization procedure are the following.

Method 1: Direct Connection from the MD to a PC

Here the second computer is a PC that is physically nearby to the MD. The connection is made using a local networking technology such as Bluetooth or USB cable. Table 1 lists some examples of MDs that can connect to PCs using this method and the identified software installed on the PC to support the synchronization.

Depending on the implementation, the user may have to manually intervene, or the steps may occur automatically. For example, some Palm MDs require the user to press a “sync” button on the MD to initiate the sync process.

Method 2: Direct Connection from the MD to a Second Computer

Here the second computer is physically separate from the MD—in fact, they may be in different continents. The MD and second computer communicate over the Internet, for example, using an Internet connection available on the MD.

For example, a RIM Blackberry device can update its stored email messages by connecting to a mail server using a common mail exchange protocol such as IMAP, POP, or Microsoft Exchange. Or, an application (such as described in the United States patent application cited earlier) can update a locally-stored cache of media files (digital content) by connecting to a second computer that stores an ever-refreshing collection of episodic media content.

This method 2 is useful in transferring information between an MD and a second computer through the Internet, assuming the MD has an active Internet connection.

### Method 3: MD Synchronizes to the Second Computer Through a PC Proxy.

Here, again, the second computer is physically separate from the MD. Communication between the MD and the second computer is through a PC, acting as a proxy. The proxy may be used because the MD lacks an active Internet connection or the quality of the PC's Internet connection is superior to the MD's connection. In this method 3, the synchronization sequence could be the following (see FIG. 2).

CONNECT: The user connects the MD to a physically nearby Internet-connected PC, using a cable or Bluetooth, for example.

The MD transfers its state (using the cable/Bluetooth connection) to the PC.

The PC transfers the MD's state to the second (e.g., remote) computer, using the Internet.

COMPUTE: (same as in General Synchronization Method)

TRANSMIT: The second computer delivers the delta file (intended for the MD) to the PC.

The PC delivers the delta file to the MD.

PERFORM: (same as in General Synchronization Method)

Method 3 is appropriate to transfer information between an MD and a second computer through the Internet, when an Internet connection is available on, and the synchronization application can be loaded and run on, a nearby proxy PC.

In an arrangement described in http://isr.cmu.edu, a MD saves its system state in persistent storage and a different device resumes from the saved state.

We now describe a way to transfer information between an MD and a second computer (in some examples, for the purpose of synchronization of content) through a nearby device (e.g., a local proxy PC) when, for example, applications are not permitted to be installed and run on the local proxy PC.

This technique is useful, for example, when the MD does not have Internet connectivity, the user has access (for example, occasional or intermittent access) to a computer or other device PC that has Internet connectivity, and the synchronization software application is not permitted to be installed or is not permitted to be used on the PC.

We describe a variant of Method 3:

Method 4: MD Synchronizes to the Second Computer Through a PC Proxy without Requiring Installed Application on the Proxy PC (e.g., a Zero-Install Procedure)

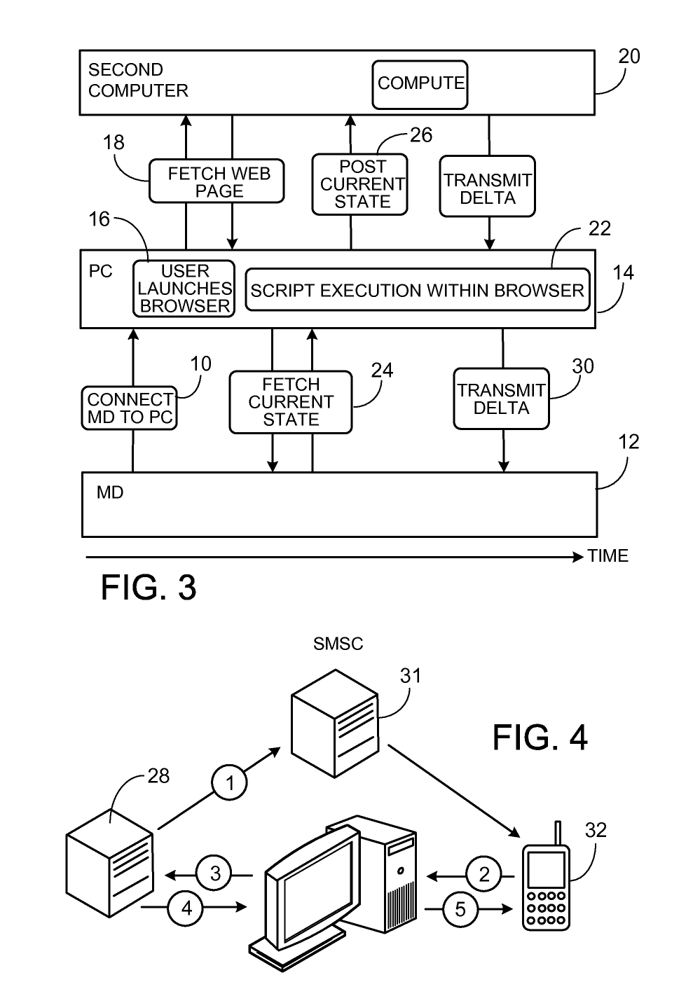

In this new method, the synchronization sequence can be as follows, for example (see FIG. 3, in which the relative positions of the arrows along an imaginary horizontal axis correspond to the relative timing of the occurrence of the actions represented by the arrows; arrows to the right represent actions that occur later than actions represented by arrows to the left):

CONNECT: The user connects 10 the MD 12 to a nearby, Internet-connected PC 14 using a cable or Bluetooth (for example).

application connection monitor process 15 (FIG. 6) on the MD detects that the connection between the MD and the PC is now active. This application on the MD displays a message 17 (FIG. 5) on the MD screen or provides another kind of alert to the user (for example audible), instructing the user to visit an identified URL of the second computer (for example www.acme.com) using a web browser on the PC.

Following the given instructions, the user launches 16 the PC's web browser and types in the URL. The PC browser fetches the web page 18 from the specified Internet host, e.g., the second computer 20.

The PC browser renders the web page. The web page includes a script, for example, that the PC browser executes 22. Execution of the script causes the PC to scan the file system 19 (FIG. 6) of the MD for (fetch 24) a file named (for instance) current_state.zip. The script uploads (posts 26) that file from the MD to the second computer.

COMPUTE: (same as in General Synchronization Method)

TRANSMIT: The browser script saves the delta file to a temporary location on the PC's file system, then writes (transmits 30) the delta file over the old delta file (not shown) on the MD.

PERFORM (same as in General Synchronization Method)

In some examples, the content synchronization service offered by the second computer can be restricted to authorized users and authorized MDs. Access can be restricted by requiring the MD to authenticate itself to the second computer. The MD can do so by writing to the current_state.zip file some information that uniquely identifies the device (e.g., a PGP encryption of the device's IMEI), and then having the second computer validate the information when it receives this file in the COMPUTE step.

The browser script may be written in an in-browser scripting language such as Javascript or ActiveX.

The example synchronization sequence described above does not tell the user when, for example, new files, music, episodes or other digital content are available at the second computer, and does not tell the user to access a proxy PC and perform the synchronization. As shown in FIG. 4, one way to alert the user is for the second computer 28 to deliver a text message (SMS) 1 though a Short-Message Service Center (SMSC) 31 to the MD 32. For example, the SMS message may say: “New content is available. To retrieve it, connect your phone to an Internet-connected PC and follow the instructions on the screen.”

When a request is made by the proxy PC (or periodically, whether requested or not), the application (on the MD, referred to above) updates the current_state.zip file so that it contains the current state of the MD. The MD application also detects when the MD is attached to the PC and pops up the message on the MD screen instructing the user to visit a specific web site on the PC. The MD application periodically scans its storage for a new directives.zip file and, when one appears, processes the instructions in it.

If the web browser on the proxy PC (a shared PC, for example, at an Internet cafe) disallows execution of scripts on pages received by its browser from a website, an alternate sequence may be used. This constraint need not be disclosed to the user, who will be led (by instructions on the screen of his MD) through the appropriate actions by the following sequence, for example:

Method 5: MD Synchronizes to the Second Computer Through a PC Proxy without Requiring Installed Application on the Proxy PC (e.g., a Zero-Install Procedure), if the Proxy PC Disallows Browser Scripting

CONNECT: As in Method 4, the user connects the MD to the physically nearby, Internet-connected PC using a cable or Bluetooth, the application on the MD detects that the connection of the MD with PC has been established, and displays a message on the MD screen, instructing the user to visit the URL of the second computer (for example www.acme.com) from a web browser on the PC. When the user launches the PC's web browser and invokes the URL, the PC browser fetches the web page from the specified second computer. The PC browser renders the web page, which includes a script, the execution of which is prevented.

The PC browser will instead execute alternate HTML code, that shows a file upload prompt on the screen, which asks the user to specify the file location of the current state.zip file on the MD.

An example of code, carried in the webpage, that can effect this sequence, follows:

<body>
<script language=“JavaScript”>
<!—Begin
window.location=“http://www.acme.com/javascript-enabled.html”;
// End -->
</script>
<noscript>
Here belongs the HTML code for browsers that do not support Javascript
Here would appear the HTML to prompt the user to upload the
current_state.zip file.
</noscript>

The user types in the location of the current_state.zip file, and the browser fetches that file and uploads it to the second computer.

COMPUTE: (same as in General Synchronization Method)

TRANSMIT: The user is prompted by the webpage to download a new current_state.zip file to the proxy PC's file system from the second computer. The user acknowledges the prompt and downloads the file to the proxy PC. The web site of the second computer redirects the user to a new page, which instructs the user to copy the new delta file to the MD file system from the proxy PC.

PERFORM: (same as above)

Referring again to FIG. 6, the second computer 20 includes a signaler 50 to provide the update message through the SMSC 31 to the MD, an AppServer 52 to manage the updating of the MD state, a web server 54 to serve webpages to the PC proxy, content storage 56 for the content items that are being synchronized, and a content ingestion process 58 that takes in content in a variety of formats from multiple external content sources.

Other examples are with the scope of the following claims, including examples encompassed within the following terms used in this description.

We use the terms digital objects, digital content, and media content, in a broad sense to include, for example, any kind of digital information in any form that is created, maintained, or used for any purpose, such as images, video, audio, television, radio, sounds, text, messages, packets, slides, presentations, software, files, databases, and data streams, and others.

We use the term mobile device in a broad sense to include, for example, any electronic device that can be held or carried or worn or otherwise moved from one location to another, including devices that are capable of wireless or wired communication and those that are not, and including hand-held mobile phones, organizers, computers, and other kinds of electronic devices, among others.

We use the term synchronize in a broad sense to include every possible kind of action that alters, supplements, replaces, removes, changes, or adjusts digital content on one device based on the nature, state, identity, quantity, make up, timing, or other characteristics of digital content that exists other than on the device, for example, on another device or devices or in another place or places, or in another form or forms, or at another time or times, among other things.

We use the term connection in a broad sense to include every possible coupling, attachment, channel, or link, of any kind, size, bandwidth, duration, extent, breadth, availability, protocol, or standard, for example, between a device and another device or devices, such as a computer, another mobile device, a network, or any other electronic device, including, for example, a local connection made through a Wi-Fi, Bluetooth, or other wireless network, a or USB cable, power system network, or other wired or wireless coupling arrangement of any kind.

We use the term network in a broad sense to include every possible interconnection arrangement that enables communication from one place to another, including, for example, the Internet, a local area network, a wide area network, an extranet, an intranet, a virtual private network, an ethernet network, a token ring network, an edge network, a wired network, a wireless network, a mesh network, and others, regardless of the connection technique, the protocol for communication on the network, the physical arrangement of the network, or the devices that form the network, for example.

We use the term connectivity in a broad sense to include any possible state in which a device is able to make or has made a connection.

We use the term delta in a broad sense to include any difference, or an expression or description of any difference, between two bodies of digital content, including, differences in, for example, one or more of quantity, identity, timing, location, subject, format, or quality, and including a description of actions that might be taken to reduce or eliminate the difference.

We use the terms local and physically nearby to include a degree of proximity such as in the same room, in the same building, in the same plane, car, boat, or other vehicle, in the same place, or within visible or audible distance.

We use the term remote in a broad sense to include a degree of distance that is greater than local or physically nearby, and includes, for example, at a different place on a network, in a different campus, complex, quarter, city, state, country, county, province, or continent, for example.

We use the terms PC and computer in a broad sense to include, for example, any computing device of any size, make, type, capacity, configuration, complement, capability, location, cost, or availability, among other things.

We use the terms second computer, Internet host, and server in a broad sense to include, for example, any computer, PC, computing or other electronic device, that provides, hosts, stores, gives access to, maintains, replicates, mirrors, delivers, sends, serves, or communicates digital content, among other things, regardless of its location, size, ownership, protection, identity, manufacturer, type, capacity, cost, or availability.

We use the terms transport and transfer in a broad sense to include, for example, sending, transmitting, receiving, accepting, communicating, packaging, delivering, or conveying in any way, at any time, and between any places.

We use the terms installation and install with respect to code in a broad sense to include, for example, creating and storing a persistent executable, for example within the file system managed by the operating system, that can be invoked by the operating system when execution of the application is requested.

We use the term persistent (and in the converse sense, non-persistent), for example, in the broad sense of lasting or continuing or being stored or available or maintained for more than a fleeting or temporary period, including, for example, at times when the device on which it exists is not powered, or at times when the facility that uses or obtains the thing (for example a browser or an application) is not running or available. For example, a difference between an installed application and a script is persistence. A browser script is non-persistent in that it exists only as long as the browser window that contains the script remains open. Once that window is closed, evidence of the script is gone from the computer. A browser script is transient. A public computer may be configured to disallow applications from being installed persistently, while permitting browser scripts to be executed.

We use the term real-time, with reference to something occurring in real-time relative to something else, in a broad sense to include, for example, the actual time when the something else occurs, or approximately the actual time, or as close to the actual time as may be possible considering network and electronic latency, but not considering delay imposed by deliberate time-consuming storage or any other deliberate delay or time-shifting, among other things.

Other implementations are within the scope of the following claims.

1. A computer-implemented method comprising
at a local device connected to a network, assisting an updating, of a mobile device that is nearby the local device, from one state to another state, the states of the mobile device being associated with digital content, the updating being based on information at a server that is accessible through the network from the local device, the updating being assisted without requiring execution on the local device of code that is persistent on the local device.

2. The method of claim 1 in which the local device comprises a computer.

3. The method of claim 1 in which the local device is connected to the Internet.

4. The method of claim 1 in which the mobile device is nearby the local device only temporarily.

5. The method of claim 1 in which the updating comprises updating a state file on the mobile device.

6. The method of claim 1 in which the digital content includes items to be presented to a user of the mobile device.

7. The method of claim 1 in which updating the mobile device comprises updating digital content that is to be presented to the user of the mobile device.

8. The method of claim 1 in which the information at the server relates to digital content that is available for presentation to a user of the mobile device.

9. The method of claim 1 comprising connecting the mobile device to the local device to assist the updating.

10. The method of claim 9 in which connecting the mobile device to the local device includes making a cable connection.

11. The method of claim 9 in which connecting the mobile device to the local device includes making a wireless connection.

12. The method of claim 1 in which assisting the updating includes actions of a user.

13. The method of claim 1 in which assisting the updating includes actions by the local device.

14. The method of claim 1 in which assisting the updating includes actions by the mobile device.

15. The method of claim 1 including executing code on the mobile device to assist in the updating.

16. The method of claim 1 including alerting the user to actions to be performed by the user to assist the updating.

17. The method of claim 1 in which the assisting of the updating comprises operation of a browser on the local device.

18. The method of claim 1 in which the assisting of the updating includes executing non-persistent code.

19. The method of claim 18 in which the non-persistent code comprises scripts delivered through a browser.

20. The method of claim 18 in which the non-persistent code comprises hypertext markup code.

21. A computer-implemented method comprising
providing an alert to a user of a mobile device to cause the user to connect the mobile device to a network-connected local device.

22. The method of claim 21 comprising
the network-connected local device helping to synchronize content on a server with content on the mobile device.

23. The method of claim 22 in which the alert is provided by displaying a message on the mobile device.

24. The method of claim 22 in which the alert is provided by rendering a sound on the mobile device.

25. The method of claim 22 in which the network comprises the Internet.

26. The method of claim 22 in which the local device comprises a computer.

27. The method of claim 22 in which the content comprises items to be presented to the user on the mobile device.

28. The method of claim 22 in which the alert indicates to the user to cause the local device to connect to the server through a browser.

29. The method of claim 22 in which the alert identifies a URL of the server.

30. The method of claim 22 in which the alert instructs a user of the MD to launch a browser on the local device.

31. The method of claim 22 in which the alert is delivered as a text message from the local device to the mobile device.

32. A computer-implemented method comprising
at a local device that is connected by a network to a server, executing non-persistent code to acquire a state of a mobile device that is nearby the local device, the state being related to content stored on the mobile device.

33. The method of claim 32 in which non-persistent code acquires a current state from the mobile device.

34. The method of claim 32 in which the non-persistent code delivers to the server current state of the mobile device.

35. The method of claim 32 in which the non-persistent code scans the mobile device for a specific file that includes a current state of the mobile device.

36. A computer-implemented method comprising
at a local device that is connected by a network to a server, alerting a user to copy a file, received from the server at the local device, from the local device to a mobile device that is nearby the local device, the file containing information associated with synchronization of content between the server and the mobile device.

37. The method of claim 36 in which the file is copied to the mobile device at a location that is known by the mobile device to contain synchronization information.
